(19) United States
(12) Patent Application Publication
(10) Pub. No.: US 2022/0303386 A1
(43) Pub. Date: Sep. 22, 2022

(54) METHOD AND SYSTEM FOR VOICE CONFERENCING WITH CONTINUOUS DOUBLE-TALK

(71) Applicant: DSP Concepts, Inc., Santa Clara, CA (US)

(72) Inventor: Paul Eric Beckmann, Sunnyvale, CA (US)

(21) Appl. No.: 17/208,209

(22) Filed: Mar. 22, 2021

(51) Int. Cl. H04M 3/00; H04L 12/18

(52) U.S. Cl. CPC H04M 3/002; H04L 12/18

(57) ABSTRACT

A method and system for improving communications conferencing systems that experience continuous double-talk where the communication includes an intended continuous or intermittent soundtrack or other intended continuous sound. The technology as disclosed and claimed herein uses several techniques to mask the residual echo and make it less audible.

### BACKGROUND

### Field

This technology as disclosed herein relates generally to voice communications and, more particularly, to voice conference with continuous or intermittent background sounds.

### Background Of Art

There are voice conferencing applications where in addition to having voice sounds from far end and near end participants being transmitted, you also have the added complexity of background sounds (movie sound, music, other sound tracks and etc.) being mixed in. This scenario could be experienced when using voice chat during video game play or voice chat while participants are concurrently watching a movie. A near end participant can be defined as a person in a near end audio space with a speaker phone or other audio communication capable device with a near end audio speaker, where the audio space can be a near end room, and where the person is speaking and the speech is referred to as near end speech. A far end participant can be defined as a person in a far end audio space communicably linked by a communication line where the far end participant is on the other end of the communication line with respect to the near end participant. If the near end participant and the far end participant are communicating with near end and far end speech at the same time and there is also an intermittent or a continuous soundtrack being output through the near end and far end speaker concurrent with the near end and far end speech, the problem of echo cancellation and double talk becomes more complex.

Typically, this is problem is resolved by wearing a headset with speakers and a microphone. However, a more robust solution is needed to provide similar functionality, but without either participant having to wear something on their head.

Voice conferencing takes a number of sophisticated algorithms to provide a natural sounding experience. As a rule, a participant never wants to hear their own echo because it will cause the participant to stop speaking. Voice conference systems use acoustic echo cancellers (AECs) to remove the echo sound produced by the loudspeaker and eliminate it at the microphones. AECs can remove most of the sound, but even the best ones leave patches of echo sound. To further remove echoes, residual echo suppression (RES) algorithms are used. There are many types of RES that have been described. Some work in the time domain; others in the frequency domain. Often, the RES algorithms attenuate all sounds (including near-end speech) and this leads to a “half duplex” situation. This is where the remote speaker is unable to hear the local speaker.

As mentioned herein, one of the most difficult processing scenarios is called “double talk”. This is when both participants are speaking at the same time. It is not desired to have a half-duplex experience but rather “full duplex” in which both participants can hear each other at the same time. This takes very sophisticated RES processing which is applied only during double talk. For example, suppose you want to have a voice conference and in addition to people talking (near end and far end participant speech), there are other sounds happening like games sounds or a movie sound (call this “added sound”). This is an even more difficult situation because traditional voice conferencing algorithms will treat the added sound as far-talk. Most games (or movies) have continuous soundtracks and as a result the voice conference system will essentially be in a continuous double talk situation whenever the near-end person speaks.

Residual echo suppression usually works by reducing the amplitude of the echo signal and this is done either on a full band or on a frequency-by-frequency basis. This leads to attenuation and artifacts in the transmitted near end speech. Normally, double talk only occurs during a small percentage of time during a conversation, and this signal degradation is often acceptable. However, in the above-described application there is added continuous or intermittent sound beyond the near end and far end speech, and therefore, a different approach is needed. Normal RES would distort all transmitted speech. A different approach is needed.

A better system and/or method is needed for improving communication conferencing systems that experience continuous double-talk.

### SUMMARY

The technology as disclosed herein includes a method and system for improving communication conferencing systems that experience continuous double-talk where the communication includes an intended continuous or intermittent soundtrack or other intended continuous sound content. One application of one implementation of the technology can be utilized in a “gamer sound-bar”. The sound-bar can be utilized in conjunction with or for gaming applications that playback a continuous or intermittent soundtrack. The sound is emitted from speakers in the sound-bar unit. Additionally, the sound-bar can be equipped with a single omni-directional or single-directional microphone or one or more microphone array(s) in order to allow for a voice chat feature so that a participant can talk naturally with their teammates that are located at a far end of the conferencing connection.

Typically, the challenge of continuous or intermittent double-talk from the continuous or intermittent soundtrack is addressed by wearing a headset with speakers in an ear-cup and a microphone built in the ear-cup or a boom microphone. The technology as disclosed and claimed herein and its various implementations and embodiments provide similar functionality but without the participant having to wear a headset. The technology as disclosed and claimed provides a solution to this problem and masks the residual echo. The technology as disclosed and claimed herein uses several techniques to mask the residual echo and make it less audible. The main approaches include mixing in the added sound from the sound track into the Tx voice signal, which will naturally mask the residual echo; controlling the aggressiveness of the RES based on the level of the extra sound — such that when the extra sound is low, then apply RES as in a standard voice call, and if the extra sound is loud, then apply less RES since the echo will be naturally masked by the extra sound; and adjusting the level of comfort noise based on how loud the extra sound is.

The far-end speech arrives at the near end and is scaled by volume control “Vol 1”. To this scaled far-end speech, the game sound scaled by “Vol 2” is added with far-end speech scaled by volume “Vol 1”, and this combined signal is played out of the loudspeaker and transmitted to the acoustic echo cancellation module. The output of “Vol 2” is referred to as the “Added Game Sound” or AGS. The near-end microphone receives an audible signal which is a combination of the near end speech and the loudspeaker output. There is a standard path including Acoustic Echo Cancellation (AEC) and Residue Echo Suppression (REC) through which the audible signal is processed along with the combined signal from “Vol 1” and “Vol 2”. The technology as disclosed and claimed deals with an intermittent or continuous soundtrack added to the standard path. The game sound is mixed in at a level of “Vol 3” into the output of the AEC and RES to produce the Tx Speech. This helps to mask the echo sound. The RES and Comfort Noise Generator (CNG) also uses the level of added sound (output of “Vol 3”==TAS) to control the level and behavior of the RES and the CNG. The output of “Vol 3” can generally be referred to as the “transmitted added sound”, or TAS.

Modulating the RES: For one implementation of the technology as disclosed and claimed, the aggressiveness of the RES is controlled based on the level of the TAS. If the TAS is low, then the RES will be aggressive. If the TAS is high, then the RES can be gentle. A masking technique can also be utilized. For one implementation, the technology performs a spectral analysis of spectral content of the TAS and the residual echo and determines the aggressiveness of the RES based on how well the TAS masks the residual echo.

Modulating the Comfort Noise Generator: The purpose of the comfort noise generator is to create shaped random noise which matches the background noise level in the room. Comfort noise is utilized because the RES affects the room noise received by the microphone. Without comfort noise, the far-end person would potentially hear the noise in the room constantly change when the RES is active. The technology as disclosed and claimed herein uses the TAS to determine how much comfort noise to add. When TAS is high, then the room noise is masked and no comfort noise is required. When TAS is low, the system uses comfort noise processing. For one implementation, separate audio inputs into the AEC and RES are utilized for the far-end speech and the TAS added sound.

One application of the technology as disclosed and claimed is that of sound-bar used with gaming applications. For one implementation, the sound is projected from 2 or more speakers in the sound-bar unit and sound is received by a microphone integrated in the sound-bar unit. Additionally, for one implementation, the technology as disclosed includes a voice chat feature so that a near-end or far-end user has the ability talk naturally with your teammates. The technology as disclosed and claimed provides similar functionality but without having to wear a headset with speakers and a microphone.

The features, functions, and advantages that have been discussed can be achieved independently in various implementations or may be combined in yet other implementations further details of which can be seen with reference to the following description and drawings.

These and other advantageous features of the present technology as disclosed will be in part apparent and in part pointed out herein below.

### BRIEF DESCRIPTION OF THE DRAWING

For a better understanding of the present technology as disclosed, reference may be made to the accompanying drawings in which:

FIG. 1A is an illustration of a conferencing network;

FIG. 1B is an illustration of a voice conferencing system for handling continuous double-talk; and

FIG. 1C is an illustration of an AEC and residual echo suppression function; and

FIG. 1D is an illustration of a voice conferencing system for handling continuous double-talk when the near-end and far-end are listening to the same Added Game Sound;

FIG. 1E is an illustration of a voice conferencing system for handling continuous double-talk when the near-end and far-end are listening to the same Added Game Sound when the far-end game sound level is known; and

FIG. 1F is an illustration of a voice conferencing system for handling continuous double-talk when the near-end and far-end are listening to the same Added Game Sound when the far-end game sound is utilized for the Echo and Comfort Noise algorithm.

While the technology as disclosed is susceptible to various modifications and alternative forms, specific implementations thereof are shown by way of example in the drawings and will herein be described in detail. It should be understood, however, that the drawings and detailed description presented herein are not intended to limit the disclosure to the particular implementations as disclosed, but on the contrary, the intention is to cover all modifications, equivalents, and alternatives falling within the scope of the present technology as disclosed and as defined by the appended claims.

### DESCRIPTION

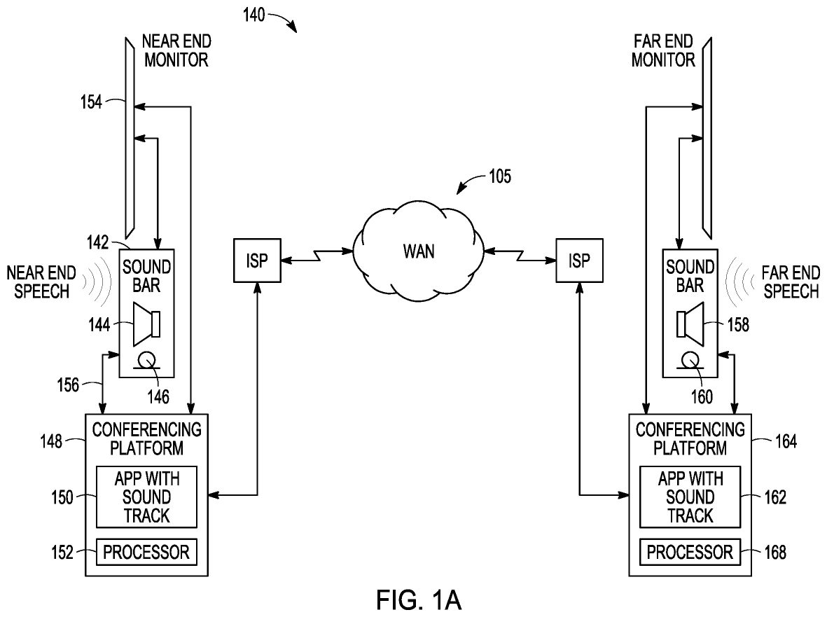

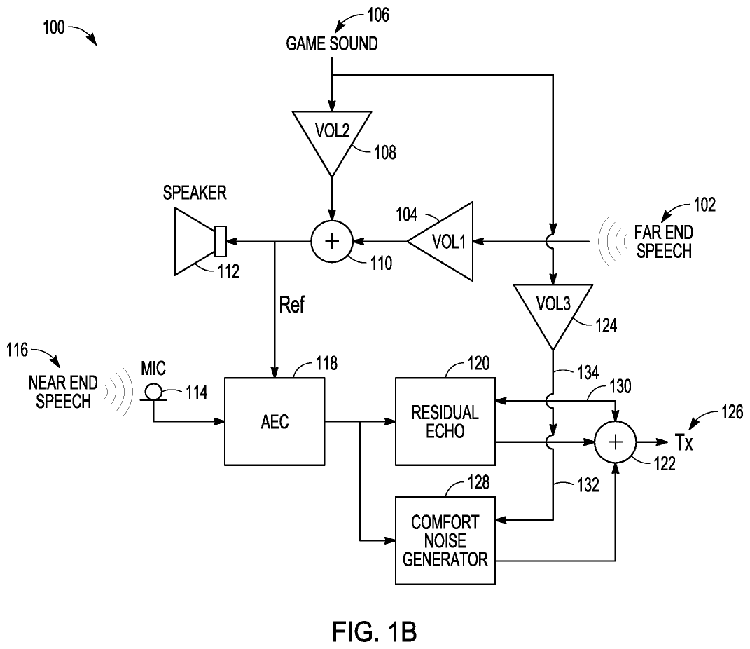

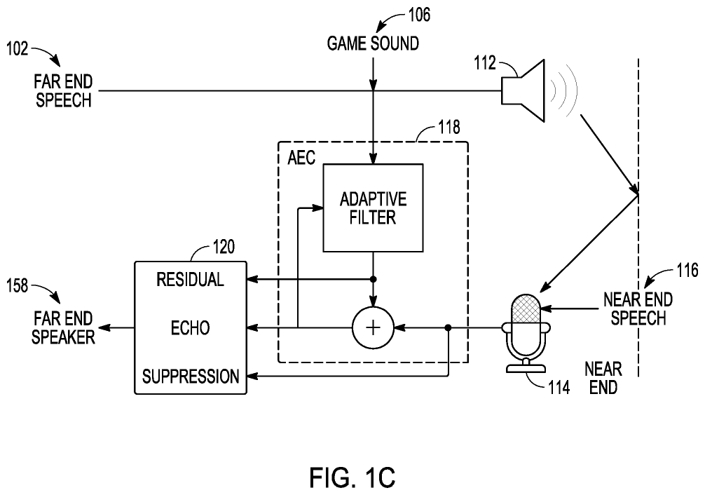

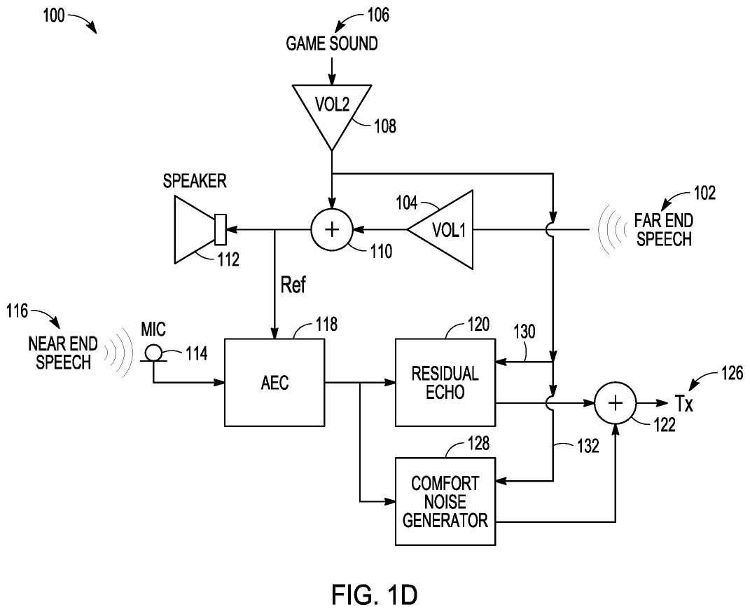

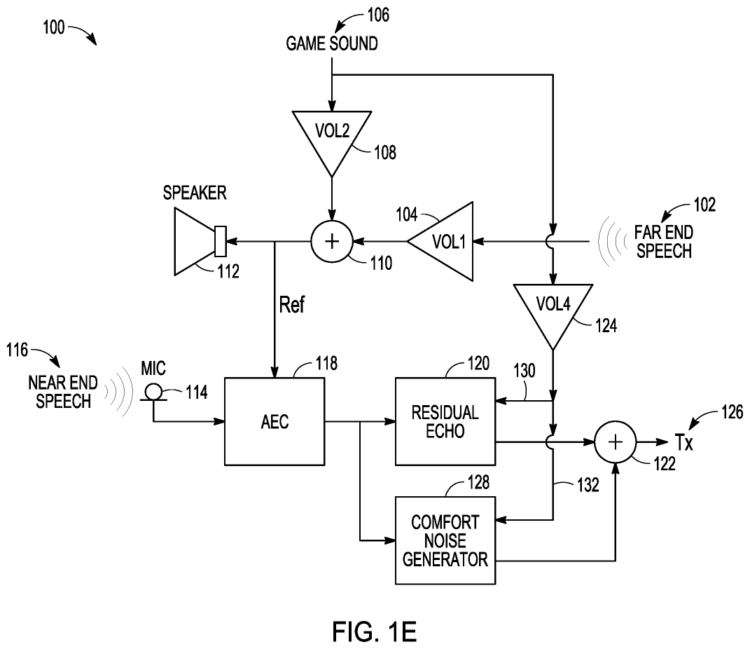

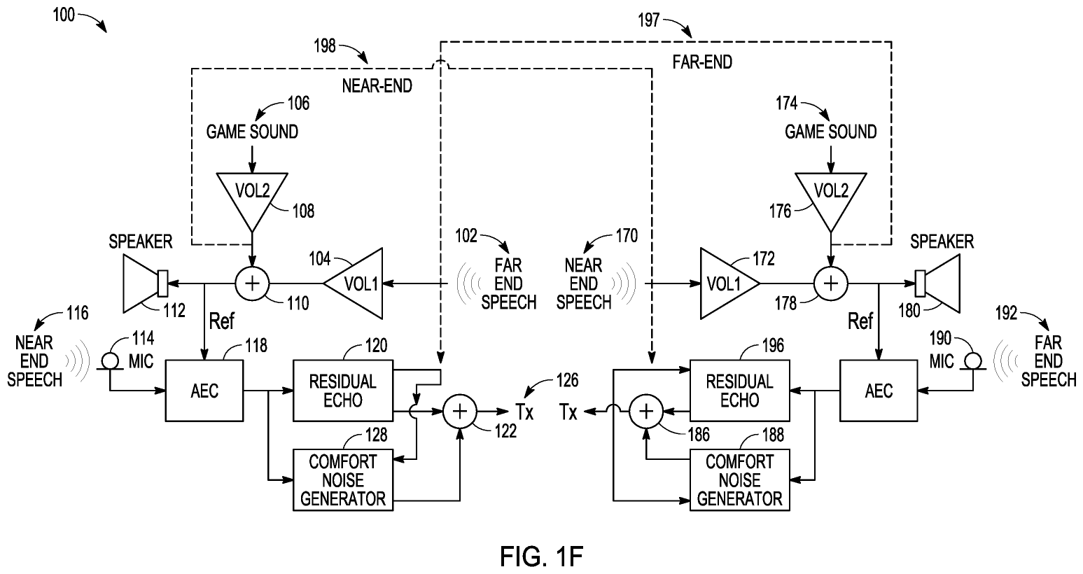

According to the implementation(s) of the present technology as disclosed, various views are illustrated in FIGS. 1A, 1B, 1C, 1D, 1E and 1F and like reference numerals are being used consistently throughout to refer to like and corresponding parts of the technology for all of the various views and figures of the drawing. Also, please note that the first digit(s) of the reference number for a given item or part of the technology should correspond to the Fig. number in which the item or part is first identified. Reference in the specification to “one embodiment” or “an embodiment”; “one implementation” or “an implementation” means that a particular feature, structure, or characteristic described in connection with the embodiment or implementation is included in at least one embodiment or implementation of the invention. The appearances of the phrase “in one embodiment” or “in one implementation” in various places in the specification are not necessarily all referring to the same embodiment or the same implementation, nor are separate or alternative embodiments or implementations mutually exclusive of other embodiments or implementations.

One implementation of the present technology as disclosed comprising a conferencing system teaches a novel system and method for a conferencing system experiencing continuous or intermittent double talk. The technology as disclosed and claimed provides a solution to this problem and masks the residual echo. The technology as disclosed and claimed herein uses several techniques to mask the residual echo and make it less audible. The main approaches include mixing in the added sound from the sound track to produce the Tx voice signal, which will naturally mask the residual echo; controlling the aggressiveness of the RES based on the level of the extra sound—such that when the extra sound is low, then apply RES as in a standard voice call, and if the extra sound is loud, then apply less RES since the echo will be naturally masked by the extra sound; and adjusting the level of comfort noise based on how loud the extra sound is.

The details of the technology as disclosed and various implementations can be better understood by referring to the figures of the drawing. Referring to FIGS. 1A, 1B and 1C, the far-end speech 102 arrives at the near end 100 and is scaled by volume control “Vol 1” 104. To this scaled far-end speech scaled through “Vol 1” 104, the game sound 106 as scaled by “Vol 2” is added 110 with the far-end speech scaled through volume “Vol 1” 104, and this combined signal is played out of the loudspeaker 112 and transmitted as a reference signal to the AEC and RES. The near-end microphone 114 receives the audible signal which is a combination of the near end speech 116 and the loudspeaker 112 output. One implementation of the near-end microphone is a single omni-directional or single directional microphone, however, for other implementations, the near-end microphone includes one or more microphone arrays. There is a standard path including Acoustic Echo Cancellation (AEC) 118 and Residue Echo Suppression (REC) 120. The technology as disclosed and claimed deals with an intermittent or continuous soundtrack, such as the game sound, added to the standard path. The game sound, or more generally the soundtrack, is mixed 122 in at a level scaled by “Vol 3” 124 with the AEC and RES outputs to thereby produce the Tx Speech 126. This helps to mask the echo sound. The RES and Comfort Noise Generator (CNG) 128 also uses the level of added sound (output of “Vol 3”) to control, 130 and 132, the level and behavior of the RES and the CNG. The output of “Vol 3” 124 can generally be referred to as the “transmitted added sound”, or TAS 134. The output of “Vol 2” is generally referred to as the “Added Game Sound, or AGS.

Modulating the Residual Echo Suppression (RES): For one implementation of the technology as disclosed and claimed, the aggressiveness of the RES 120 is controlled based on the level of the TAS 134. If the TAS is low, then the RES will be aggressive. If the TAS is high, then the RES can be gentle. The TAS is fed back 130 to the RES as a control parameter. A masking technique can also be utilized. For one implementation, the technology performs a spectral analysis of spectral content of the TAS and the residual echo suppression and determines the aggressiveness of the RES based on how well the TAS masks the residual echo.

Modulating the Comfort Noise Generator (CNG): The purpose of the comfort noise generator 128 is to create shaped random noise which matches the background noise level in the room. Comfort noise is required because of the RES effects of the room noise received by the microphone 114. Without comfort noise, the far-end person would potentially hear the noise in the room constantly change when the RES 120 is active. The technology as disclosed and claimed herein uses the TAS 134 to determine how much comfort noise to add. The TAS 134 is fed back 132 to the RES 120 as a control parameter. When TAS 134 is high, then the room noise is masked and no comfort noise is required. When TAS is low, the system uses comfort noise processing 128. For one implementation, separate audio inputs into the AEC 118 and RES 120 are utilized for the far-end speech 102 and the TAS 134 added sound.

One application of the technology as disclosed and claimed is that of sound-bar 142 used with gaming application systems 148. For one implementation, the sound is projected from one or more speakers 144 in the sound-bar unit 142 and sound is received by a microphone 146 integrated in the sound-bar unit 142. The technology as disclosed and claimed provides a voice chat feature so that a user has the ability to talk naturally with their teammates. The technology as disclosed and claimed provides similar functionality but without having to wear a headset with speakers and a microphone.

One implementation of the technology as disclosed and claimed is a conferencing system 140 for transmission of voice and background sounds includes a conferencing application 150 operating on a server 148 or other computing device coupled on a network 148 thereby establishing a conferencing link between a near-end conferencing application generated user interface, which for one implementation is interactive with various input devices such as a mouse, keyboard, joystick or other input device that communicates with the server 148, and the user interface is displayed on a monitor 154, said near-end user interface having a near-end speaker 144 and a near-end microphone 146 are communicably coupled 156 with a near-end computing device 148 processing with a processor 152 said near-end user interface, and a far-end conferencing application 162 generated user interface having a far-end speaker 158 and a far end microphone 160 coupled with a far end computing device 164 processing with a processor 168 said far end user interface.

For one implementation of the technology as disclosed and claimed, the conferencing application 150 processing with a processor 152 on the computing device 148, generates one or more of intermittent and continuous soundtrack signals. The near-end conferencing application 150 generated user interface and said far-end conferencing application 162 generated user interface receives and projects voice sound signals with the microphones 146 and 160 and receives and projects the one or more of the intermittent and continuous soundtrack signals produced by the conferencing applications 150 and 162 processing with the processors 152 and 168 on the computing devices 148 and 164. For one implementation of the technology as disclosed and claimed, the conferencing application 150 has a near-end digital signal processor function processing on the processor 152 that combines one or more of the intermittent and continuous sound track with an AEC and RES processed near-end speech signal thereby generating and outputting a Tₓ 126 voice signal. For one implementation of the technology as disclosed and claimed, the near-end digital signal processor function adjusts a level of a residual echo suppression 120 responsive to the level and frequency contents of the one or more intermittent and continuous soundtrack signal.

For one implementation of the conferencing system as disclosed and claimed the conferencing application has a far-end digital signal processor function being processed by the processor 168 that combines one or more of the intermittent and continuous sound track with a far-end AEC and RES processed far-end speech signal thereby generating and outputting the far-end speech signal 102. For one implementation, the conferencing application 150 has the near-end digital signal processor function processing on the processor 152 that combines one or more of the intermittent and continuous sound track 134 with comfort noise generator 128 signal processed near-end speech output to thereby generate and output the Tₓ voice signal 126. For one implementation the near-end digital signal processor function adjusts a level of a comfort noise generator 128 responsive to the level and frequency contents of the one or more intermittent or continuous soundtrack signal 134. For one implementation of the technology as disclosed and claimed, the conferencing application is a gaming application where the gaming application generates the one or more of intermittent and continuous soundtrack signal. For one implementation, the near-end digital signal processor function is integrated with a sound-bar and where the near-end speaker and near-end microphone are part of the sound-bar 142, and where the near-end speaker 144 and the near-end microphone 146 are integrally coupled with the near-end digital signal processor function.

One implementation of the technology as disclosed and claimed is a method of conferencing for transmitting voice and background sound including operating a conferencing application 150 with a processor 152 on a server coupled or other computing device 148 on a network 148, such as a Wide Area Network (WAN), including and Internet Service Provider (ISP) and thereby establishing a conferencing link between a near-end conferencing application generated user interface, and a far-end conferencing application generated user interface, where the near-end user interface has a near-end speaker 144 and a near-end microphone 146 coupled with a near-end computing device 148 and thereby processing said near-end user interface with the processor 152 and displaying the user interface on a near end monitor 154. The method includes a far-end conferencing application generating a far end user interface having a far-end speaker and a far end microphone coupled with a far end computing device and thereby processing with a far-end processor 168 said far end user interface. One implementation of the method including generating one or more of intermittent and continuous soundtrack signals with said conferencing applications and receiving and projecting the one or more intermittent and continuous soundtrack at said near-end conferencing application generated user interface and receiving and projecting at said far-end conferencing application generated user interface, voice sound signals and the one or more of the intermittent and continuous soundtrack signals. The method includes combining one or more of the intermittent and continuous sound track with an AEC and RES processed near-end speech signal with said conferencing application having a near-end digital signal processor function, thereby generating and outputting a Tₓ voice signal, where the near-end digital signal processor function is adjusting a level of a residual echo suppression responsive to the level and frequency contents of the one or more intermittent and continuous soundtrack signal.

One implementation of the method of conferencing as disclosed and claimed herein includes combining one or more of the intermittent and continuous sound track with an AEC and RES processed far-end speech signal thereby generating and outputting a Tₓ voice signal with said conferencing application having a far-end digital signal processor function. One implementation of the method of conferencing includes combining one or more of the intermittent and continuous sound track with comfort noise generator signal processed near-end signal to thereby generate and output the Tₓ voice signal with said conferencing application having the near-end digital signal processor function. For one implementation of the method of conferencing the near-end digital signal processor function is adjusting a level of a comfort noise generator responsive to the level and frequency contents of the one or more intermittent and continuous soundtrack signal.

For one implementation of the technology as disclosed and claimed a non-transitory computer-readable medium storing a conferencing application including instructions that, when executed by a computing processor, causes establishing a conferencing link through user interfaces, to operate a conferencing application on a server coupled on a network and thereby establish a conferencing link between a near-end conferencing application generated user interface, said near-end user interface having a near-end speaker and a near-end microphone coupled with a near-end computing device and thereby process said near-end user interface, and a far-end conferencing application generated user interface having a far-end speaker and a far end microphone coupled with a far end computing device and thereby processing said far end user interface, and causes the generation of one or more of intermittent and continuous soundtrack signals with said conferencing applications and causes the receipt and projection of the near-end conferencing application generated user interface and receipt and projection at said far-end conferencing application generated user interface, voice sound signals and the one or more of the intermittent and continuous soundtrack signals. For one implementation causes the combining of one or more of the intermittent and continuous sound track with an AEC and RES processed near-end speech signal with said conferencing application having a near-end digital signal processor function, thereby generating and outputting a Tₓ voice signal, where the near-end digital signal processor function is adjusting a level of a residual echo suppression responsive to the level and frequency contents of the one or more intermittent and continuous soundtrack signal.

Referring to FIG. 1D, an illustration is shown of a voice conferencing system for handling continuous double-talk when the near-end and far-end are both listening to the same or similar Added Game Sound and both have double-talk handling systems. As illustrated by the configuration shown in FIG. 1B, the game sound is added into the transmitted signal at a level of “VOL 3”. However, for one potential implementation, the far-end system is the same as the near-end system, therefore, the far-end system is already mixing in an added game sound at a level of “VOL 2F” with “F” designating far-end. With this configuration, the far-end added game sound will accomplish the masking that is needed. With this configuration, the near-end system doesn't have to mix in the game sound since the far-end is already mixing the game sound in. For this configuration, the logic used for the near-end residual echo suppression and comfort noise generation is not based on “VOL 3”.

This implementation is similar to the one shown earlier in FIG. 1B. The main difference is that the Vol 3 has been removed and therefore, the Transmitted Added Sound (TAS) is zero. This implementation is used if both the near-end and the far-end have the same or similar Added Game Sound masking echoes. The logic for the Residual Echo Suppression and Comfort Noise Generator module and/or algorithm function is based on the level of the Added Game Sound AGS of VOL2 108. If both the near-end and far-end are listening to the same Game Sound, then the Game Sound at the far-end will mask echoes generated by the near-end. Similarly, the Game Sound at the near-end will mask echoes generated by the far-end, therefore, there isn't a need for the masking function of the TAS of VOL3 as illustrated in FIG. 1B.

The implementation in FIG. 1D assumes that the level of Added Game Sound is the same in the near-end and far-end systems. This is a reasonable initial default starting point, but each system generally has its own separate volume controls. That is, the near-end system has a volume control VOL2 which adjust how much Game Sound is mixed in at the near-end and the far-end has its own volume control VOL2F which adjusts how much game sound is mixed in at the far-end. FIG. 1E builds upon FIG. 1D and adds a separate volume control VOL4 reflects the volume control VOL2F at the far-end. This provides a more accurate indication of how much masking will result from the AGS at the far-end. Referring to FIG. 1E, an illustration is shown of a voice conferencing system for handling continuous double-talk where the near-end and far-end are listening to the same Added Game Sound and where the far-end game sound level is known.

Referring to FIG. 1F, an illustration is shown of a voice conferencing system for handling continuous double-talk where the near-end and far-end are listening to the same Added Game Sound 174 and 106, and where the far-end game sound 197 is utilized for the Echo and Comfort Noise algorithm. For one implementation, the far-end system is the same as the near-end system, in that there is near end speech 150 received and processed by VOL 1 172 and is mixed 178 with the game sound 174 processed by VOL 2 176, therefore, the far-end system is already mixing 178 in an added game sound at a level of “VOL 2F” 176 with “F” designating far-end. With this configuration, the far-end added game sound will accomplish the masking that is needed. With this configuration, the near-end system doesn't have to mix 110 in the game sound 106 since the far-end is already mixing 178 the game sound 174 in and is projected through speaker 180 and is provided as a reference to the AEC 194, which receives the far end speech 192 through the far end microphone 190 and processes the signal for the far end residual echo 196 and comfort noise generator 188 modules whose output signals are combined 186 for a far end Tx output. For this configuration, the logic used for the near-end residual echo suppression and comfort noise generation is not based on “VOL 3”, but is based on the far-end VOL2 176.

The various implementations and examples shown above illustrate a method and system for conferencing system experiencing continuous or intermittent double talk. The technology as disclosed and claimed provides a solution to this problem and masks the residual echo. The technology as disclosed and claimed herein uses several techniques to mask the residual echo and make it less audible. The main approaches include mixing in the added sound from the sound track into the Tx voice signal, which will naturally mask the residual echo; controlling the aggressiveness of the RES based on the level of the extra sound—such that when the extra sound is low, then apply RES as in a standard voice call, and if the extra sound is loud, then apply less RES since the echo will be naturally masked by the extra sound; and adjusting the level of comfort noise based on how loud the extra sound is. A user of the present method and system may choose any of the above implementations, or an equivalent thereof, depending upon the desired application. In this regard, it is recognized that various forms of the subject conferencing method and system could be utilized without departing from the scope of the present technology and various implementations as disclosed.

As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the and scope of the present implementation(s). Accordingly, the specification and drawings are to be regarded in an illustrative rather than a restrictive sense.

Certain systems, apparatus, applications or processes are described herein as including a number of modules or components. A module may be a unit of distinct functionality that may be presented in software, hardware, or combinations thereof. For example, a module can include the acoustic echo cancellation (AEC), the Residual Echo Suppression (RES) and the Comfort Noise Generator (CNG). When the functionality of a module is performed in any part through software, the module includes a computer-readable medium. The modules may be regarded as being communicatively coupled with other modules for example the AEC, RES and the CNG are communicably couples. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an example implementation, the machine operates as a standalone device or may be connected (e.g., networked) to other machines such as a far end and near-end systems connected of a WAN. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine or computing device. Further, while only a single machine is illustrated, the term “machine” shall also be taken to include any collection of machines that individually or jointly execute a set (or multiple sets) of instructions to perform any one or more of the methodologies discussed herein.

The example computer system and client computers can include a processor (e.g., a central processing unit (CPU) a graphics processing unit (GPU) or both), a main memory and a static memory , which communicate with each other via a bus. The computer system may further include a video/graphical display unit (e.g., a liquid crystal display (LCD) or a cathode ray tube (CRT)). The computer system and client computing devices can also include an alphanumeric input device (e.g., a keyboard), a cursor control device (e.g., a mouse), a drive unit, a signal generation device (e.g., a speaker) and a network interface device.

The drive unit includes a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

The various implementations and examples shown above illustrate a conferencing system that addressed continuous Double Talk. A user of the present technology as disclosed may choose any of the above implementations, or an equivalent thereof, depending upon the desired application. In this regard, it is recognized that various forms of the subject conferencing application could be utilized without departing from the scope of the present invention.

As is evident from the foregoing description, certain aspects of the present technology as disclosed are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the scope of the present technology as disclosed and claimed.

Other aspects, objects and advantages of the present technology as disclosed can be obtained from a study of the drawings, the disclosure and the appended claims.

1-24. (canceled)

25. A method of audio conferencing, comprising:
receiving a soundtrack signal;
receiving a far-end audio signal from a far end;
combining the soundtrack signal with the far-end audio signal to generate a far-end reference signal;
playing back the far-end reference signal through a near-end speaker;
generating a near-end audio signal with a near-end microphone;
generating a near-end transmit speech signal by performing acoustic echo cancellation and residual echo suppression on the near-end audio signal, wherein a level of the residual echo suppression that is performed depends on the level of the soundtrack signal; and
transmitting the near-end transmit speech signal to the far end.

26. The method of audio conferencing of claim 25, wherein the soundtrack signal is a near-end soundtrack signal, the method comprising:
combining the near-end soundtrack signal with the far-end audio signal to generate the far-end reference signal; and
generating the near-end transmit speech signal by performing acoustic echo cancellation and residual echo suppression on the near-end audio signal, wherein a level of the residual echo suppression that is performed depends on the level of the near-end soundtrack signal.

27. The method of audio conferencing of claim 26, further comprising:
receiving the near-end transmit speech signal at the far end;
receiving a far-end soundtrack signal;
combining the far-end soundtrack signal with the near-end transmit speech signal thereby generating a near-end reference signal; and
playing back the near-end reference signal through a far-end speaker.

28. The method of audio conferencing of claim 27, further comprising:
generating a far-end audio signal with a far-end microphone;
performing acoustic echo cancellation and residual echo suppression on the far-end audio signal to generate a far-end transmit speech signal, wherein a level of the residual echo suppression that is performed is responsive to the level of the far-end soundtrack signal; and
transmitting the far-end transmit speech signal to the near end.

29. The method of audio conferencing of claim 25, wherein generating the near-end transmit speech signal further comprises:
adding comfort noise to the near-end transmit speech signal.

30. The method of audio conferencing of claim 29, wherein a level of the comfort noise added to the near-end transmit speech signal depends on the level of the soundtrack signal.

31. The method of audio conferencing of claim 25, wherein the soundtrack signal is a far-end soundtrack signal, the method comprising:
combining the far-end soundtrack signal with the far-end audio signal to generate a far-end reference signal; and
generating the near-end transmit speech signal by performing acoustic echo cancellation and residual echo suppression on the near-end audio signal, wherein the level of the residual echo suppression that is performed depends on the level of the far-end soundtrack signal.

32. The method of audio conferencing of claim 31, further comprising:
receiving the near-end transmit speech signal at the far end;
combining the far-end soundtrack signal with the near-end transmit speech signal thereby generating a near-end reference signal; and
playing back the near-end reference signal through a far-end speaker.

33. The method of audio conferencing of claim 31, wherein generating the near-end transmit speech signal further comprises:
adding comfort noise to the near-end transmit speech signal.

34. The method of audio conferencing of claim 33, wherein a level of the comfort noise added to the near-end transmit speech signal depends on the level of the far-end soundtrack signal

35. A non-transitory computer-readable medium, the computer-readable medium including instructions that when executed by a computer, cause the computer to perform operations for providing audio conferencing, comprising:
receiving a soundtrack signal;
receiving a far-end audio signal from a far end;
combining the soundtrack signal with the far-end audio signal to generate a far-end reference signal;
playing back the far-end reference signal through a near-end speaker;
generating a near-end audio signal with a near-end microphone;
generating a near-end transmit speech signal by performing acoustic echo cancellation and residual echo suppression on the near-end audio signal, wherein a level of the residual echo suppression that is performed depends on the level of the soundtrack signal; and
transmitting the near-end transmit speech signal to the far end.

36. The non-transitory computer-readable medium of claim 35, wherein the operation of generating the near-end transmit speech signal further comprises:
adding comfort noise to the near-end transmit speech signal.

37. The non-transitory computer-readable medium of claim 36, wherein a level of the comfort noise added to the near-end transmit speech signal depends on the level of the soundtrack signal.

38. The non-transitory computer-readable medium of claim 35, wherein the soundtrack signal is a near-end soundtrack signal, and the level of the residual echo suppression that is performed depends on the level of the near-end soundtrack signal.

39. The non-transitory computer-readable medium of claim 35, wherein the soundtrack signal is a far-end soundtrack signal, and the level of the residual echo suppression that is performed depends on the level of the far-end soundtrack signal.

40. An audio conferencing system that provides audio conferencing based at least in part on a soundtrack signal and a far-end audio signal received from a far end, the system comprising:
a module to combine the soundtrack signal with the far-end audio signal to generate a far-end reference signal;
an output for playing the far-end reference signal back through a near-end speaker;
an input for receiving a near-end audio signal from a near-end microphone;
an acoustic echo cancellation and residual echo suppression module to generate a near-end transmit speech signal by performing acoustic echo cancellation and residual echo suppression on the near-end audio signal, wherein a level of the residual echo suppression that is performed depends on the level of the soundtrack signal.

41. The audio conferencing system of claim 40 wherein the soundtrack signal is a near-end soundtrack signal, and the level of the residual echo suppression that is performed depends on the level of the near-end soundtrack signal.

42. The audio conferencing system of claim 40 wherein the soundtrack signal is a far-end soundtrack signal, and the level of the residual echo suppression that is performed depends on the level of the far-end soundtrack signal.

43. The audio conferencing system of claim 40 further comprising:
a comfort noise generating module to add comfort noise to the near-end transmit speech signal, the level of the comfort noise depending on the level of the soundtrack signal.

44. The audio conferencing system of claim 40, further comprising:
a near-end sound-bar including the near-end speaker and the near-end microphone, wherein the acoustic echo cancellation and residual echo suppression module are implemented in one or more digital signal processors in the near-end sound-bar.
